(19) United States
(12) Patent Application Publication
(10) Pub. No.: US 2020/0057302 A1
(43) Pub. Date: Feb. 20, 2020

(54) DIFFRACTION GRATING STRUCTURE, AUGMENTED REALITY APPARATUS INCLUDING THE SAME, AND METHOD OF MANUFACTURING DIFFRACTION GRATING STRUCTURE

(71) Applicant: Samsung Electronics Co., Ltd., Suwon-si (KR)

(72) Inventors: Nikolay Victorovich MURAVEV, Moscow (RU); Dmitriy Evgenyevich PISKUNOV, Moscow (RU); Jaeyeol RYU, Moscow (RU)

(21) Appl. No.: 16/543,024

(22) Filed: Aug. 16, 2019

(30) Foreign Application Priority Data
Aug. 16, 2018 (RU) 2018129788
May 22, 2019 (KR) 10-2019-0060258

(51) Int. Cl. G02B 27/01; F21V 8/00

(52) U.S. Cl. CPC G02B 27/0101; G02B 6/0035

(57) ABSTRACT

A diffraction grating structure, an augmented reality apparatus including the same, and a method of manufacturing the diffraction grating structure are provided. The diffraction grating structure includes first and second substrates spaced apart from each other, a photodirector layer arranged between the first and second substrates and including an interference pattern formed therein, and a liquid crystal layer arranged on the photodirector layer and including liquid crystals oriented to correspond to the interference pattern and liquid crystals arranged in a chaotic state. Thus, an augmented reality apparatus having a large viewing angle due to the above diffraction grating structure may be implemented.

### CROSS-REFERENCE TO RELATED APPLICATION(S)

This application is based on and claims priority of a Russian patent application number 2018129788, filed on Aug. 16, 2018, in the Russian Patent Office and claims priority of a Korean patent application number 10-2019-0060258, filed on May 22, 2019, in the Korean Intellectual Property Office, the disclosures of each of which are incorporated by reference herein in their entirety.

### BACKGROUND

### 1. Field

The disclosure relates to diffraction grating structures of various structures, augmented reality apparatuses including the same, and methods of manufacturing diffraction grating structures.

### 2. Description of Related Art

Recently, augmented reality apparatuses have gained popularity among users of electronic devices by adding virtual information or images to actual images displayed on electronic devices in order to supplement information about the actual images and improve information recognition.

As a viewing angle increases, more augmented reality information may be arranged when using augmented reality and therefore, recent augmented reality apparatuses may need to increase a viewing angle (field of view) up to 60° in a horizontal direction, which is the most comfortable viewing angle for users.

A core component of an augmented reality apparatus is an image combining device (combiner) that combines an environment image with an image generated by an internal display. Up to now, the most compact combiners have been developed based on diffraction gratings of waveguides or based on holographic optical elements. In general, a combiner may be a waveguide including diffraction gratings arranged at an input terminal and an output terminal, and light having passed through a first diffraction grating located at the input terminal may be propagated through the waveguide and output from the waveguide through a second diffraction grating located at the output terminal.

As the refractive index of the waveguide and the diffraction grating increases, the viewing angle increases and therefore, in order to make a large viewing angle, it may be advantageous that the refractive index for the material of both the waveguide and the diffraction grating is relatively large. Because polymers used to manufacture the diffraction grating have a low refraction constant, the material of a holographic grating may have a low refractive index. Also, the modulation of a refractive index in the polymers is low, which may necessitate increasing the thickness of the material in order to provide high efficiency resulting in high angular selectivity, which may limit the viewing angle. In addition, the manufacturing of the holographic grating may require complex chemical processing and mechanical tooling. In manufacturing a general diffraction grating embedded in a waveguide, it may be difficult to make a structure small enough to be used in a compact combiner.

A diffraction grating based on liquid crystals may be used instead of a holographic grating or a general diffraction grating. The diffraction grating based on liquid crystals may provide phase modulation of light by applying a voltage corresponding to a fixed transparent electrode to a liquid crystal cell. The refractive index of a liquid crystal diffraction grating may be larger than the refractive index of a holographic diffraction grating, and the viewing angle may increase when the liquid crystal diffraction grating is used. However, in order to use a liquid crystal cell, application of voltage, that is a power supply, may be required, and a plurality of associated electrodes may be required such that the design thereof may be complicated. Also, electrodes on a substrate of the liquid crystal cell may influence spatial resolution.

One of the solutions for overcoming the above drawbacks of the diffraction grating based on liquid crystals is, for example, to use polymers as disclosed in U.S. Pat. No. 9,090,822 B2, published on Jul. 28, 2015. The '822 patent discloses polymerizable compounds, manufacturing methods thereof, and the use for optoelectronic-optical and electronic purposes (particularly, liquid crystals) and the use in medium and liquid crystal displays (particularly, polymer sustained (PS) or polymer sustained alignment (PSA) type liquid crystal displays). However, the drawback of this solution is that the disclosed polymers are only used to orient liquid crystals in a cell.

The main drawbacks of the related art include:
Complex chemical processing and/or machining complexity in making compact diffraction gratings;
Modulation of refractive indexes and low refractive indexes resulting in small viewing angles;
Image quality degradation due to low spatial resolution of transparent electrodes in the case of using liquid crystals; and
The need for a power supply when using liquid crystals and design complexity due to connection with a plurality of electrodes.

The above information is presented as background information only, and to assist with an understanding of the disclosure. No determination has been made, and no assertion is made, as to whether any of the above might be applicable as prior art with regard to the disclosure.

### SUMMARY

Aspects of the disclosure are to address at least the above-mentioned problems and/or disadvantages, and to provide at least the advantages described below. Accordingly, an aspect of the disclosure is to provide an apparatus and method for a compact diffraction grating structure and a method of manufacturing the same.

Another aspect of the disclosure is to provide an apparatus and method for a diffraction grating structure having no power source or using only one or two electrodes and a method of manufacturing the same.

Another aspect of the disclosure is to provide an apparatus and method for a diffraction grating structure with a high spatial resolution and a method of manufacturing the same.

Another aspect of the disclosure is to provide an apparatus and method for an augmented reality apparatus including the above diffraction grating structure.

Additional aspects will be set forth in part in the description which follows and, in part, will be apparent from the description, or may be learned by practice of the presented embodiments of the disclosure.

In accordance with an aspect of the disclosure, a diffraction grating structure is provided. The diffraction grating structure includes first and second substrates spaced apart from each other, a photodirector layer arranged between the first and second substrates and including an interference pattern formed therein, and a liquid crystal layer arranged on the photodirector layer and including liquid crystals, wherein the liquid crystals include liquid crystals oriented to correspond to the interference pattern and liquid crystals arranged in a chaotic state.

In accordance with another aspect of the disclosure, the oriented liquid crystals are arranged on a region of the photodirector layer where an intensity of the interference pattern is nonzero.

In accordance with another aspect of the disclosure, the liquid crystals arranged in the chaotic state are arranged on a region of the photodirector layer where an intensity of the interference pattern is zero.

In accordance with another aspect of the disclosure, the photodirector layer includes a polyimide material.

In accordance with another aspect of the disclosure, the interference pattern is formed by irradiating a plurality of lights with different optical characteristics.

In accordance with another aspect of the disclosure, polarization characteristics of at least two of the plurality of lights are different from each other.

In accordance with another aspect of the disclosure, the liquid crystal layer further includes polymers, and at least some of the polymers may be polymerized.

In accordance with another aspect of the disclosure, the polymerized polymers are aligned in an orthogonal structure.

In accordance with another aspect of the disclosure, the diffraction grating structure further includes first and second electrodes arranged on the first and second substrates respectively.

In accordance with another aspect of the disclosure, the oriented liquid crystals and the liquid crystals arranged in the chaotic state are configured to overlap the first and second electrodes in a thickness direction of the liquid crystal layer.

In accordance with another aspect of the disclosure, the liquid crystals arranged in the chaotic state are configured to maintain the chaotic state even with a voltage applied to the first and second electrodes.

In accordance with another aspect of the disclosure, an orientation direction of the oriented liquid crystals is adjusted according to a voltage applied to the first and second electrodes.

In accordance with another aspect of the disclosure, a spatial resolution of the diffraction grating structure is determined by a resolution of the interference pattern.

In accordance with another aspect of the disclosure, the first substrate includes a waveguide.

In accordance with another aspect of the disclosure, an augmented reality apparatus is provided. The augmented reality apparatus includes a waveguide, and the above diffraction grating structure arranged on the waveguide.

In accordance with another aspect of the disclosure, a method of manufacturing a diffraction grating structure is provided. The method includes applying a photodirector layer on a substrate, irradiating a plurality of lights with different optical characteristics onto the photodirector layer to form an interference pattern in the photodirector layer, and arranging liquid crystals on the photodirector layer with the interference pattern formed therein to arrange some of the liquid crystals in an oriented state and arrange the others of the liquid crystals in a chaotic state.

In accordance with another aspect of the disclosure, the arranging of the liquid crystals includes arranging the liquid crystals in the oriented state on a region of the photodirector layer where an intensity of the interference pattern is nonzero and arranging the liquid crystals in the chaotic state on a region where an intensity of the interference pattern is zero.

In accordance with another aspect of the disclosure, polarization characteristics of at least two of the plurality of lights are different from each other.

In accordance with another aspect of the disclosure, the plurality of lights include a combination of at least one of a plane wave, a square wave, a convergent wave, a divergent wave, or a parallel wave.

In accordance with another aspect of the disclosure, the method further includes mixing the liquid crystals with polymers.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is a diagram illustrating a diffraction grating structure according to an embodiment of the disclosure;

FIG. 2 is a diagram illustrating a first substrate and a photodirector layer in a diffraction grating structure of FIG. 1 according to an embodiment of the disclosure;

FIG. 3 is a diagram for describing a method of forming an interference pattern in a photodirector layer according to an embodiment of the disclosure;

FIG. 4 is a diagram for describing a method in which a liquid crystal layer is oriented on a photodirector layer with an interference pattern formed therein according to an embodiment of the disclosure;

FIG. 5 is a diagram illustrating a diffraction grating structure according to another embodiment of the disclosure;

FIG. 6A is a diagram illustrating a refractive index profile depending on a first voltage applied to a diffraction grating structure of FIG. 5 according to an embodiment of the disclosure;

FIG. 6B is a diagram illustrating a refractive index profile depending on a second voltage applied to a diffraction grating structure of FIG. 5 according to an embodiment of the disclosure;

FIG. 7 is a diagram illustrating a diffraction grating structure according to another embodiment of the disclosure;

FIG. 8 is a reference diagram for describing a method of generating a diffraction grating structure based on a mixture of liquid crystals and polymers according to another embodiment of the disclosure;

FIG. 9A is a reference diagram for describing a process of manufacturing a diffraction grating structure with a sawtooth refractive index profile recorded therein according to an embodiment of the disclosure;

FIG. 9B is a reference diagram for describing a process of manufacturing a diffraction grating structure with a rectangular profile of refractive indexes according to an embodiment of the disclosure;

FIG. 9C is a reference diagram for describing a process of manufacturing a diffraction grating structure with a sinusoidal profile of refractive indexes according to an embodiment of the disclosure;

FIG. 9D is a reference diagram for describing a process of manufacturing a diffraction grating structure with a random shape profile of refractive indexes according to an embodiment of the disclosure;

FIG. 10 is a diagram illustrating an interference pattern for a Fresnel lens according to an embodiment of the disclosure;

FIG. 11A is a reference diagram for describing a process of manufacturing a diffraction grating structure that may operate as a positive Fresnel lens according to an embodiment of the disclosure;

FIG. 11B is a reference diagram for describing a process of manufacturing a diffraction grating structure that may operate as a negative Fresnel lens according to an embodiment of the disclosure;

FIG. 12A is a diagram illustrating an example in which one region of a waveguide becomes a substrate of a diffraction grating structure according to an embodiment of the disclosure;

FIG. 12B is a diagram illustrating an example of coupling a diffraction grating structure to one region of a waveguide according to an embodiment of the disclosure;

FIG. 12C is a diagram illustrating an example of a diffraction grating structure without an electrode according to an embodiment of the disclosure;

FIG. 12D is a diagram illustrating an example of a diffraction grating structure without a substrate according to an embodiment of the disclosure;

FIG. 13A is a diagram illustrating an example of an augmented reality apparatus including a diffraction grating structure according to an embodiment of the disclosure;

FIG. 13B is a diagram illustrating a refractive index profile of the diffraction grating structure applied in FIG. 13A according to an embodiment of the disclosure;

FIG. 14A is a diagram illustrating an augmented reality apparatus including first and second diffraction grating structures according to another embodiment of the disclosure;

FIG. 14B is a diagram illustrating a refractive index profile of the first diffraction grating structure of FIG. 14A according to an embodiment of the disclosure;

FIG. 14C is a diagram illustrating a refractive index profile of the second diffraction grating structure of FIG. 14A according to an embodiment of the disclosure;

FIG. 15A is a reference diagram illustrating a relationship between a viewing angle and a light propagation path to a diffraction grating structure according to an embodiment of the disclosure;

FIG. 15B is a diagram illustrating three modes of light propagating through a diffraction grating structure and a waveguide according to an embodiment of the disclosure;

FIG. 16 is a diagram illustrating a viewing angle graph as a frequency function of a diffraction grating structure according to an embodiment of the disclosure;

FIG. 17 is a reference diagram for describing an example of dividing a viewing angle into two components according to an embodiment of the disclosure; and

FIG. 18 is a reference diagram for describing a method of implementing a dynamic diffraction grating structure according to an embodiment of the disclosure.

Throughout the drawings, like reference numerals will be understood to refer to like parts, components, and structures.

### DETAILED DESCRIPTION

The following description with reference to the accompanying drawings is provided to assist in a comprehensive understanding of various embodiments of the disclosure as defined by the claims and their equivalents. it includes various specific details to assist in that understanding, but these are to be regarded as merely exemplary. Accordingly, those of ordinary skill in the art will recognize that various changes and modifications of the various embodiments described herein can be made without departing from the scope and spirit of the disclosure. in addition, descriptions of well-known functions and constructions may be omitted for clarity and conciseness. For example, the structure or apparatus described herein may be implemented by using any number of embodiments of the disclosure described herein. Also, it is to be understood that any embodiment of the disclosure may be implemented by using one or more components recited in the appended claims.

The terms and words used in the following description and claims are not limited to the bibliographical meanings, but are merely used to enable a clear and consistent understanding of the disclosure. Accordingly, it should be apparent to those skilled in the art that the following description of various embodiments of the disclosure is provided for illustration purpose only, and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

The term “example” may be used herein to mean “used as an example or illustration”. Any embodiment of the disclosure described herein as an “example” should not necessarily be construed as desirable or advantageous over other embodiments of the disclosure.

The term such as “comprise” or “include” used herein should not be construed as necessarily including all of the elements or operations described herein, and should be construed as not including some of the described elements or operations or as further including additional elements or operations.

As used herein, the terms “over” or “on” may include not only “directly over” or “directly on” but also “indirectly over” or “indirectly on”. Hereinafter, embodiments of the disclosure will be described in detail merely as examples with reference to the accompanying drawings.

Although terms such as “first” and “second” may be used herein to describe various elements or components, the elements or components should not be limited by the terms. These terms are only used to distinguish one element or component from another element or component.

Throughout the disclosure, the expression “at least one of a, b or c” indicates only a, only b, only c, both a and b, both a and c, both b and c, all of a, b, and c, or any other variations thereof.

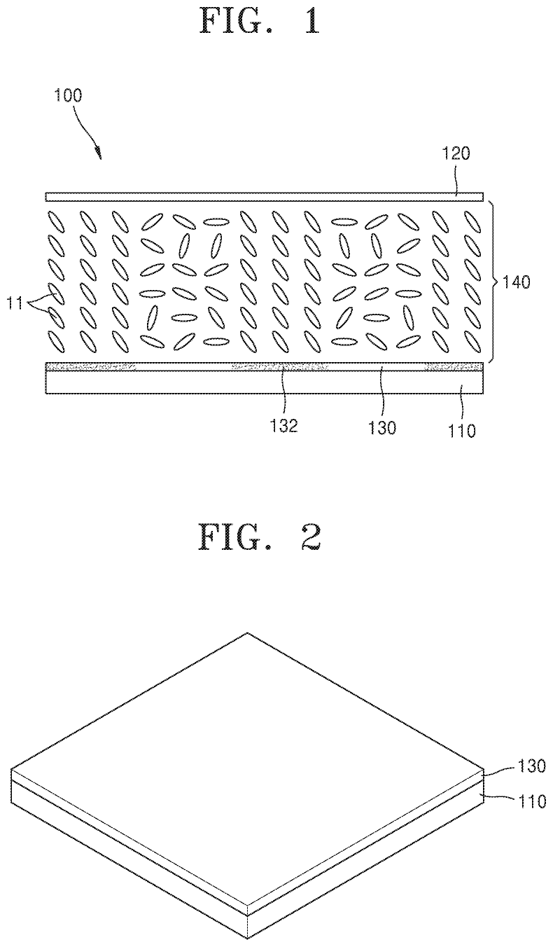

FIG. 1 is a diagram illustrating a diffraction grating structure according to an embodiment of the disclosure.

Referring to FIG. 1, a diffraction grating structure 100 may include first and second substrates 110 and 120 spaced apart from each other, a photodirector layer 130 arranged between the first and second substrates 110 and 120 and having an interference pattern 132 formed therein, and a liquid crystal layer 140 arranged on the photodirector layer 130 and including liquid crystals 11.

The first and second substrates 110 and 120 may be transparent substrates. For example, the first and second substrates 110 and 120 may be glass substrates.

The photodirector layer 130 may be formed in the interference pattern 132 to cause interference photoalignment. The interference pattern 132 may be formed by irradiating a plurality of lights with different optical characteristics onto the photodirector layer 130. For example, two polarized lights interfering with each other may be irradiated onto the photodirector layer 130, and the molecules of the photodirector layer 130 may be oriented to correspond to the interference pattern of light. This may be referred to as an interference photoalignment method. The molecules of the photodirector layer 130 may be oriented at positions where the intensity of the interference pattern of light is nonzero and may not be oriented at positions where the intensity of the interference pattern of light has a zero-intensity band. As such, the arrangement pattern of molecules in the photodirector layer 130 by the interference pattern of light may be referred to as the interference pattern 132.

The photodirector layer 130 may be in the form of a thin film and may be formed of a photosensitive material. For example, the photodirector layer 130 may be formed of a material such as polyimide, but embodiments are not limited thereto.

The liquid crystal layer 140 may be arranged on the photodirector layer 130. The liquid crystal layer 140 may include the liquid crystals 11. When the liquid crystals 11 fall onto the oriented photodirector layer 130, the liquid crystals 11 may be oriented in the direction of the oriented molecules of the photodirector layer 130. That is, the liquid crystals 11 may be oriented at positions where the intensity of the interference pattern 132 is nonzero, and the liquid crystals 11 may not be oriented or may be arranged in a chaotic arrangement, that is, a random arrangement, at positions where the intensity of the interference pattern 132 has a zero-intensity band. Particularly, the liquid crystals may be well oriented at positions where the intensity of the interference pattern is maximum.

Hereinafter, a method of manufacturing the diffraction grating structure will be described. FIG. 2 is a diagram illustrating a first substrate and a photodirector layer according to an embodiment of the disclosure.

Referring to FIG. 2, the photodirector layer 130 may be formed on the first substrate 110. The photodirector layer 130 may be in the form of a thin film and may be formed of a photosensitive material.

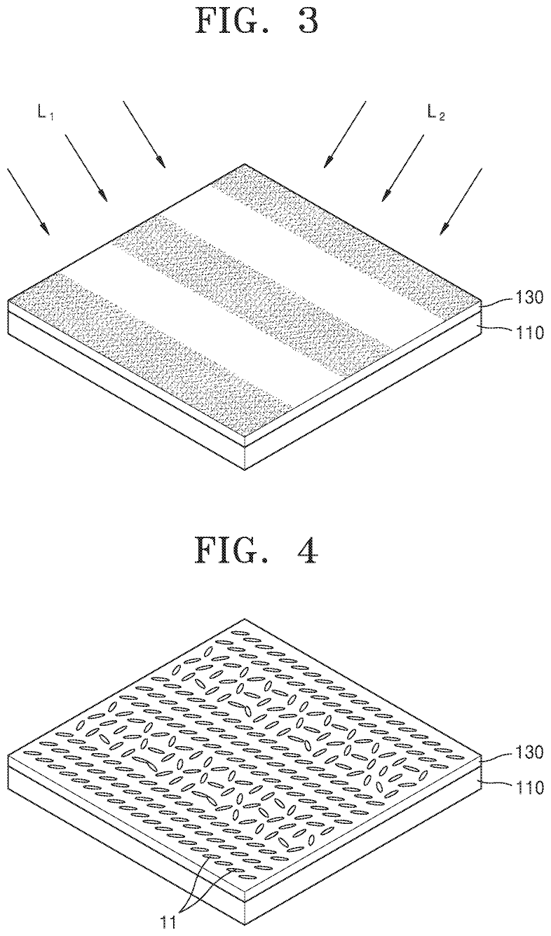

FIG. 3 is a diagram for describing a method of forming an interference pattern in a photodirector layer according to an embodiment of the disclosure.

Referring to FIGS. 1 and 3, the interference pattern 132 may be formed in the photodirector layer 130. The interference pattern 132 may be formed by irradiating a plurality of lights L1 and L2 with different optical characteristics onto the photodirector layer 130. For example, two polarized lights L1 and L2 interfering with each other may be irradiated onto the photodirector layer 130, and the molecules of the photodirector layer 130 may be oriented to correspond to the interference pattern of light. The molecules of the photodirector layer 130 may be well oriented at positions where the intensity of the interference pattern of light is maximum and may not be oriented at positions where the intensity of the interference pattern of light has a zero-intensity band.

FIG. 4 is a diagram for describing a method in which a liquid crystal layer is oriented on a photodirector layer with an interference pattern formed therein according to an embodiment of the disclosure.

Referring to FIGS. 1 and 4, a liquid crystal layer may be formed by applying the liquid crystals 11 to the photodirector layer 130 with the interference pattern 132 formed therein. When the liquid crystals 11 fall onto the oriented photodirector layer 130, the liquid crystals 11 may be oriented in the direction of the oriented molecules of the photodirector layer 130. That is, the liquid crystals 11 may be oriented at positions where the intensity of the interference pattern 132 is nonzero, and the liquid crystals 11 may not be oriented or may be arranged in a chaotic arrangement, that is, a random arrangement, at positions where the intensity of the interference pattern 132 has a zero-intensity band.

The spatial resolution of the diffraction grating structure 100 may be defined by the resolution of the interference pattern 132. That is, the diffraction grating structure 100 according to an embodiment of the disclosure may be defined by the size of the liquid crystals 11, and may implement a high spatial resolution that may not be implemented in a mechanical diffraction grating structure.

Although FIG. 1 illustrates that the photodirector layer 130 is arranged on the first substrate 110, the disclosure is not limited thereto. The photodirector layer 130 may be arranged on the second substrate 120 or on both the first and second substrates 110 and 120. Alternatively, two photodirector layers 130 spaced apart from each other may be arranged without a separate substrate.

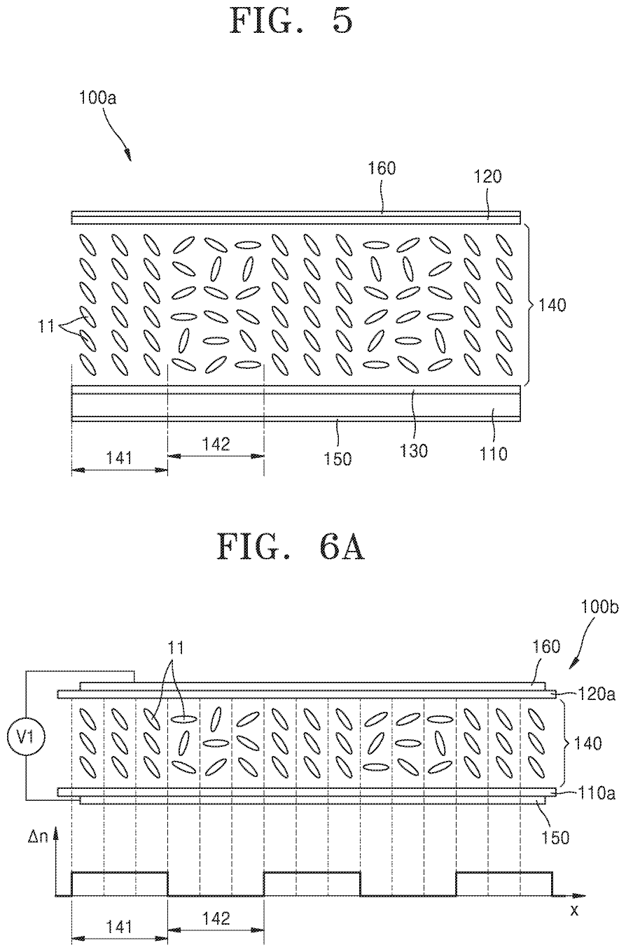

FIG. 5 is a diagram illustrating a diffraction grating structure according to another embodiment of the disclosure.

Referring to FIG. 5, a diffraction grating structure 100a may further include first and second electrodes 150 and 160 arranged on the first and second substrates 110 and 120 respectively. The first and second electrodes 150 and 160 may be transparent electrodes. For example, the first and second electrodes 150 and 160 may conduct a current and may be manufactured from materials such as transparent ITO, IZO, carbon tubes, or other materials. In the diffraction grating structure 100a of FIG. 5, the refractive index of the liquid crystal layer 140 may be adjusted by applying a voltage to the first and second electrodes 150 and 160.

When an electric field is formed in the liquid crystal layer 140 by the voltage applied to the first and second electrodes 150 and 160, the liquid crystals 11 may tend to rotate along the electric field line. Preliminarily oriented liquid crystals 11 may rotate in the same direction without interfering with each other's directions. Chaotically arranged liquid crystals 11 may not rotate because they attempt to rotate in different directions and change each other's directions and interfere with each other.

Thus, when a voltage is applied to the first and second electrodes 150 and 160, the liquid crystals 11 oriented to correspond to the interference pattern 132 may be realigned by the applied voltage and the refractive index of a region 141 (hereinafter referred to as a ‘first region’) of the liquid crystal layer 140 where the oriented liquid crystals 11 are located may be changed. Thus, the phase of light passing through the first region 141 may be modulated corresponding to the changed refractive index. The liquid crystals 11 arranged in a chaotic order may not react to the applied voltage and the refractive index thereof may not change. That is, the average refractive index may be maintained. Thus, the phase of light passing through a region 142 (hereinafter referred to as a ‘second region’) of the liquid crystal layer 140 where the liquid crystals 11 arranged in a chaotic order are located may be modulated to a certain size regardless of voltage application.

As a result, when the voltage is applied, the oriented liquid crystals 11 may change the refractive index but the chaotically arranged liquid crystals 11 may not react to the applied voltage and may not change their characteristics. Thus, the spatial resolution of the diffraction grating structure 100a may be defined by the resolution of the interference pattern 132, not by the distance between the electrodes. That is, while the resolution of a diffraction pattern in a mechanical diffraction structure is defined by the distance between electrodes, the diffraction grating structure 100 according to an embodiment of the disclosure may be defined by the size of the liquid crystals 11 and may implement a high spatial resolution that may not be implemented in a mechanical diffraction grating structure.

In order to generate the diffraction grating structure 100a according to an embodiment of the disclosure, it may be sufficient to use only one or two electrodes because a portion where the chaotic liquid crystals 11 are located when the voltage is applied does not change its characteristic and a portion where the oriented liquid crystals 11 are located changes its refractive index according to the applied voltage. Thus, the oriented liquid crystals 11 and the liquid crystals 11 arranged in a chaotic state may overlap the first and second electrodes 150 and 160 in the thickness direction of the liquid crystal layer 140.

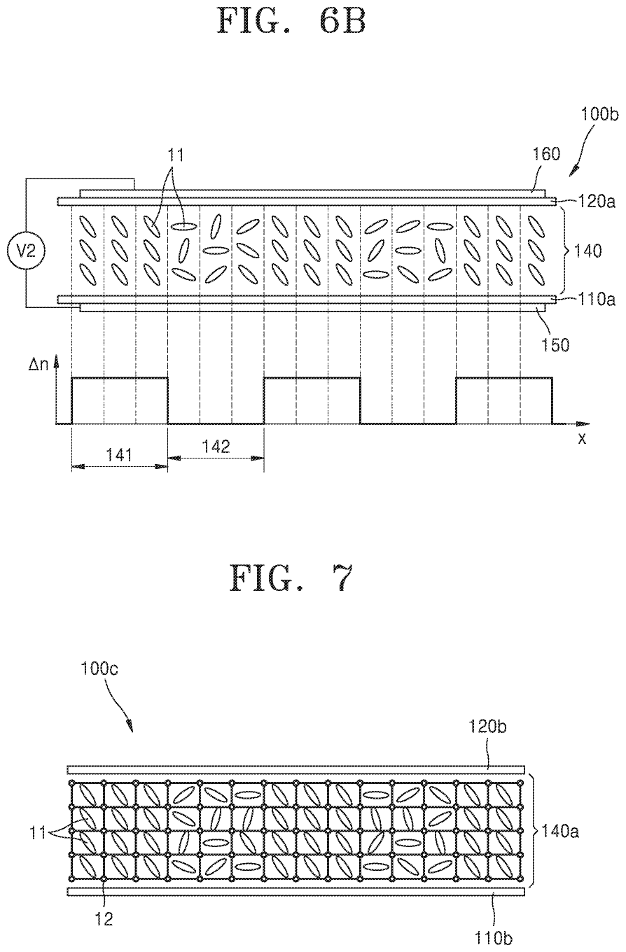

FIG. 6A is a diagram illustrating a refractive index profile depending on a first voltage applied to the diffraction grating structure of FIG. 5, and FIG. 6B is a diagram illustrating a refractive index profile depending on a second voltage applied to the diffraction grating structure of FIG. 5 according to an embodiment of the disclosure.

Referring to FIGS. 6A and 6B, in order to change the refractive index profile, a diffraction grating structure 100b according to an embodiment of the disclosure may include first and second substrates 110a and 120a spaced apart from each other, a liquid crystal layer 140 arranged between the first and second substrates 110a and 120a, and first and second electrodes 150 and 160 arranged on the first and second substrates 110a and 120a, respectively. Here, at least one of the first and second substrates 110a and 120a may include a photodirector layer (not illustrated) with a diffraction pattern formed therein. The photodirector layer may be arranged between the substrates 110a and 120a and the liquid crystal layer 140. Only two electrodes may be used in the diffraction grating structure 100b, and the first region 141 of the diffraction grating structure 100b where the oriented liquid crystals 11 are located may change the refractive index depending on the applied voltage.

FIG. 6A is a diagram illustrating a refractive index profile when a first voltage V1 is applied, and FIG. 6B is a diagram illustrating a refractive index profile when a second voltage V2 is applied. In this illustration, Δn is a change in the refractive index and V1 and V2 are applied voltages. Because the refractive index in the first region 141 where the liquid crystals 11 are oriented may be controlled according to the applied voltage, the efficiency of the diffraction grating structure 100b may be controlled.

No change in the refractive index may be observed even when there is a voltage change in the second region 142 where the chaotically oriented liquid crystals 11 are arranged. The spatial resolution of the diffraction grating structure 100b may be defined by the period of the interference pattern 132 used to form the diffraction grating structure 100b.

FIG. 7 is a diagram illustrating a diffraction grating structure according to another embodiment of the disclosure.

Referring to FIG. 7, a diffraction grating structure 100c may include first and second substrates 110b and 120b spaced apart from each other, and a liquid crystal layer 140a arranged between the first and second substrates 110b and 120b and including liquid crystals 11.

At least one of the first and second substrates 110b and 120b may further include an orientation layer (not illustrated). The orientation layer may be formed by a mechanical orientation method or an interference photoalignment method. An orientation layer where an interference pattern is formed by light may be referred to as a photodirector layer including an interference pattern. The first and second substrates 110b and 120b may be oriented without a separate orientation layer. Thus, the first and second substrates 110b and 120b may be referred to as a substrate including an orientation layer.

The liquid crystal layer 140a may further include polymers 12. The diffraction grating structure 100 including the liquid crystals 11 may perform a wide range of refractive index modulation because the liquid crystals 11 have a high refractive index. However, the polymers 12 may function to fix the liquid crystals 11. The polymers may be photopolymers.

An operation of preparing a mixture including the liquid crystals 11 and the polymers 12 may be included to generate the diffraction grating structure 100c including the liquid crystals 11 and the polymers 12. For this, polymer dispersed liquid crystals (PDLC) may be used, that is, the operation of preparing the mixture may include an operation of preparing a mixture of polymers 12 and liquid crystals 11 dispersed therein and a concentration of the polymers 12 in the liquid crystals 11 may be in the range of about 30% to about 80%.

The polymers 12 may be cured in a mixture of liquid crystals 11 and polymers 12, and inclusions of the liquid crystals 11 may be in a structure of the polymers 12. The inclusions may generally have a micron or nano size. When an electric field is applied, the inclusions may not change a relative position with respect to the polymers 12, but the liquid crystals 11 in the inclusions may be oriented across the electric field.

A liquid crystal mixture with polymers 12 may be prepared, and in this case, a concentration of photopolymers may be very low and may be less than about 1%. The liquid crystal mixture may not include inclusions of the liquid crystals 11, and conversely, a group of liquid crystals 11 may be divided by small regions including the molecules of the polymers 12.

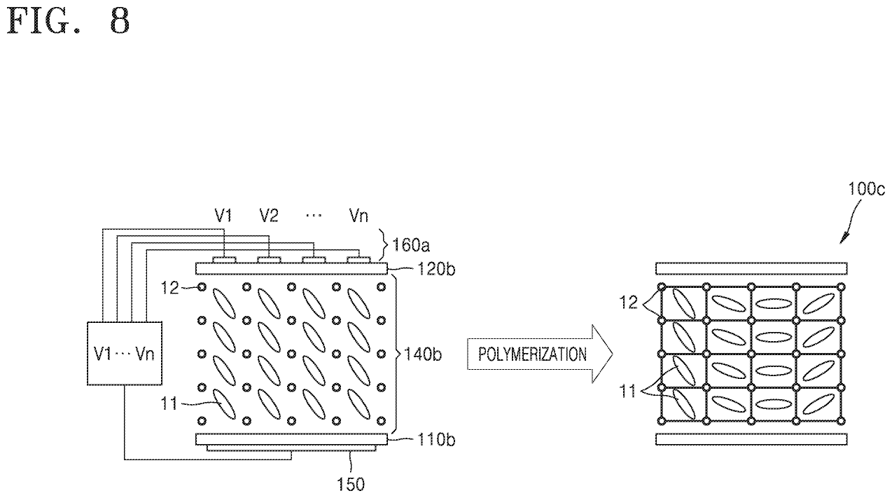

FIG. 8 is a reference diagram for describing a method of generating a diffraction grating structure based on a mixture of liquid crystals and polymers according to another embodiment of the disclosure.

Referring to FIGS. 7 and 8, a mixture including liquid crystals 11 and polymers 12 may be arranged between the first and second substrates 110b and 120b. The molecules of the polymers 12 are represented by circles, and the molecules of the liquid crystals 11 are represented by ellipses. As illustrated in FIG. 8, the mixture 140b of liquid crystals 11 and polymers 12 having an oriented direction, also referred to as a liquid crystal layer 140b, may be located between the first and second substrates 110b and 120b. When the liquid crystals 11 fall onto an orientation layer, they may have an orientation along the orientation of the orientation layer, that is, along the length of the substrate. The orientation of the orientation layer may be formed by a mechanical orientation method or an interference photoalignment method.

Lower and upper electrodes 150 and 160a may be arranged on the respective substrates 110b and 120b. The arrangement of the lower and upper electrodes 150 and 160a may be random such as annular, concentric, or irregular, and the shape of the electrodes may also be random. A certain arrangement of electrodes may be selected, and the electrode arrangement may be determined by the requirements for the resulting diffraction grating structure 100c to be generated and may be determined, for example, by a desirable period for the resulting diffraction grating structure 100c to be generated.

Two or more conductors having different potentials, that is, the lower and upper electrodes 150 and 160a, may be required to generate an electric field. The lower electrode 150 illustrated in the lower portion of FIG. 8 may be provided as one electrode to provide a so-called total or zero potential. The upper electrode 160a illustrated in the upper portion of FIG. 8 may include a plurality of unit electrodes that are independent of each other. Each unit electrode may be provided with a potential (voltage) different from the total or zero potential, which may generate a region where the liquid crystals 11 have different orientations (under the electrodes) according to the applied voltage. The period of the electrode may correspond to the required period of the diffraction grating structure 100c. The value of the voltage may depend on a selected mixture of liquid crystals 11.

A voltage (V1, V2 . . . Vn) may be supplied to each of the lower and upper electrodes 150 and 160a, and the liquid crystals 11 may rotate according to the supplied voltage. Thus, the polymers 12 may be aligned and the polymers 12 may be moved such that the oriented liquid crystals 11 may be aligned therebetween. The value of the supplied voltage may depend on the required parameter of the diffraction grating structure 100c. The liquid crystals 11 receiving the electric field may rotate to be parallel to the electric field line.

When an electric field is applied to the liquid crystal layer 140b by the lower electrode 150 and the upper electrode 160a, the liquid crystals 11 may rotate and have a particular position to attract the molecules of the polymers 12. The polymers 12 may be arranged in an orthogonal structure in which the oriented liquid crystals 11 of the liquid crystals 11 are arranged. In order to fix the diffraction grating structure 100c, the liquid crystal layer 140 may be exposed to ultraviolet radiation or heat, where this method may depend on the characteristics of the type of the selected polymers 12. That is, the molecules of the polymers 12 may be polymerized, and the regions of the polymers 12 where the groups of liquid crystals are arranged may have an orthogonal structure.

A process of generating the diffraction grating structure 100c of FIG. 8 will now be described in greater detail below.

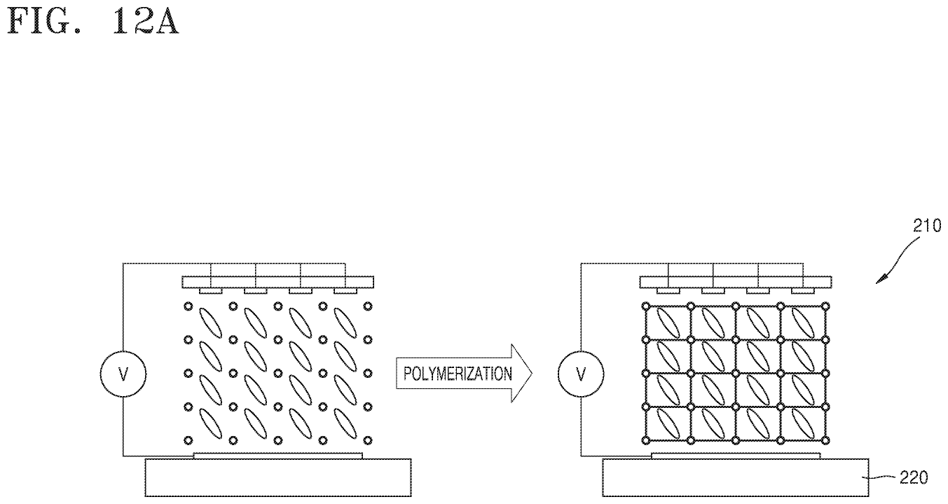

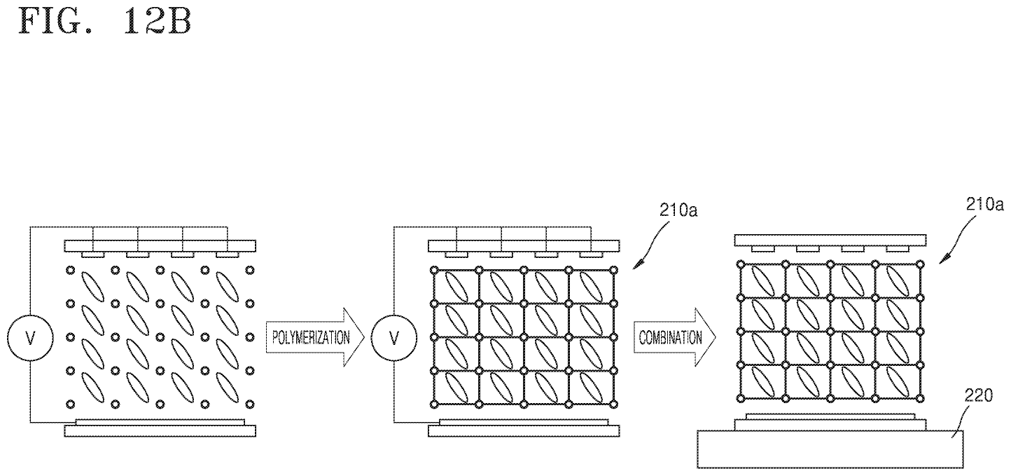

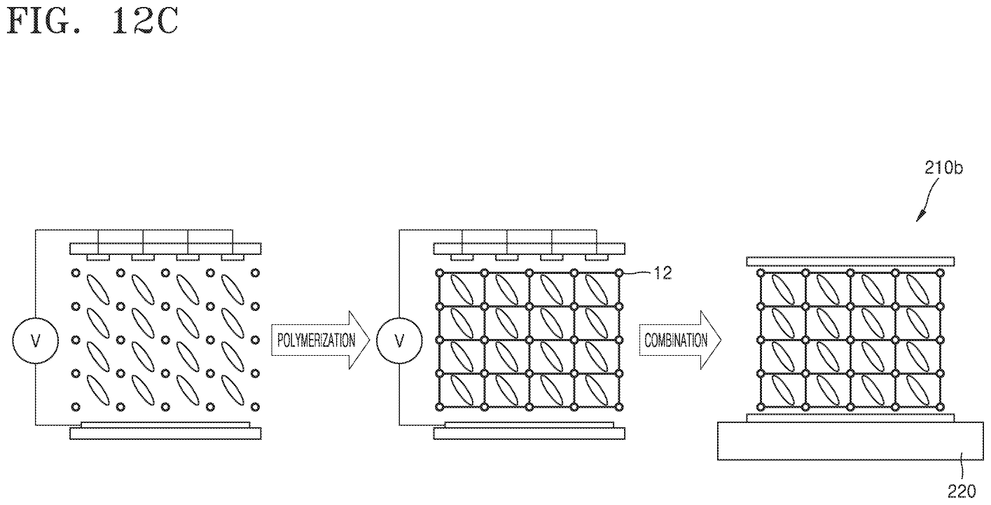

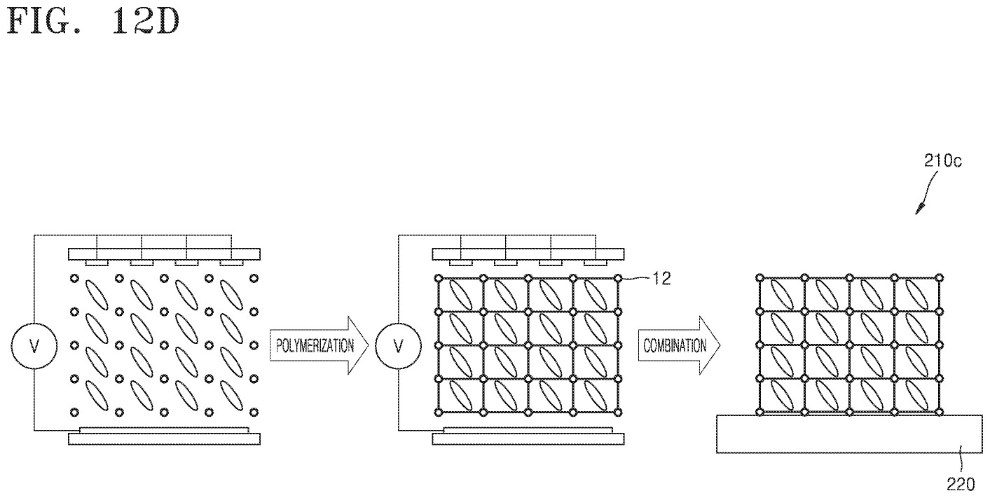

Above all, the liquid crystals 11 may not rotate in a vertical plane (i.e., a plane perpendicular to the length of the substrate or the length of a waveguide 220 as shown in FIGS. 12A to 12D) without accurate orientation. Therefore, the orientation layer may need to be provided with an orientation along the length of the substrate such that the liquid crystals 11 rotate vertically through the voltage. The rotation value (angle) of the liquid crystals 11 may depend on the value of the applied voltage. Before the liquid crystal mixture (or liquid crystal layer) 140b is arranged between the substrates, the orientation layer may be applied onto each substrate. In doing so, because the orientation layer is oriented along the length of the substrate, when the liquid crystals 11 fall onto the orientation layer, the liquid crystals 11 may have an orientation according to the orientation acquired by the orientation layer. The orientation layer may be oriented by any known method described above, for example, by photoalignment or by rubbing the orientation layer. In the case of orienting the orientation layer in a mechanical method such as rubbing, the spatial resolution of the diffraction grating structure 100c may be determined by the period between electrodes spaced apart from each other, and in the case of orienting the orientation layer by photoalignment such as an interference pattern, the spatial resolution of the diffraction grating structure 100c may be determined by the period of the interference pattern.

The refractive index profile based on the period between the electrodes will now be described in greater detail below.

A refractive index profile of the diffraction grating structure 100c may be generated according to voltage application. The voltage between adjacent electrodes in N groups may be defined as a function Δn(V), where Δn is a change in the refractive index and V is a voltage. When a voltage is applied to the mixture, the liquid crystals 11 may rotate and thus the rotation angle and Δn may vary according to the applied voltage. Simultaneously, all the liquid crystals 11 under one particular electrode may rotate at the same angle. The rotation angle may increase as the voltage increases. The rotation angle limit may be 90 degrees, and a particular voltage Vmax may correspond thereto. The liquid crystals 11 may no longer rotate even when the voltage value is greater than the particular voltage. Various orientations (rotations) of the liquid crystals 11 may cause modulation of the refractive index in the waveguide 220, thus generating a required phase pattern.

Each of the electrodes, for example, each of the unit electrodes, may be supplied with its own particular voltage. For example, voltages may be alternately provided as follows. N electrodes having the same voltage different from a zero voltage and M electrodes having a zero voltage may be alternately arranged. Here, N=1, M=1, and N+M may constitute the period of the diffraction grating structure 100n. Then, the diffraction grating structure 100n may have a linear refractive index profile.

The polymers 12 may be polymerized by irradiating ultraviolet rays onto the mixture or heating the mixture, simultaneously with the application of the applied voltage as described above. A process of fixing the polymers 12 may be referred to as polymerization, wherein the liquid crystals 11 may be fixed between the molecules of the polymers 12 and thus the liquid crystals 11 may no longer change the direction. It may be said that phase modulation is recorded in the diffraction grating structure where the polymers 12 are polymerized. The voltage and the power source may be removed, and the recorded diffraction grating structure may be arranged on the waveguide 220. The above diffraction grating structure may have a predetermined phase modulation.

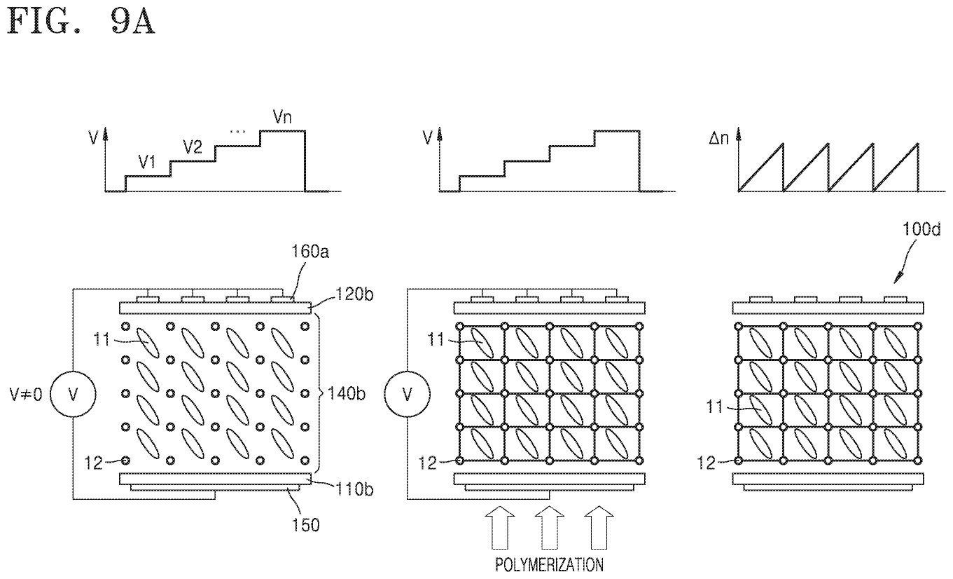

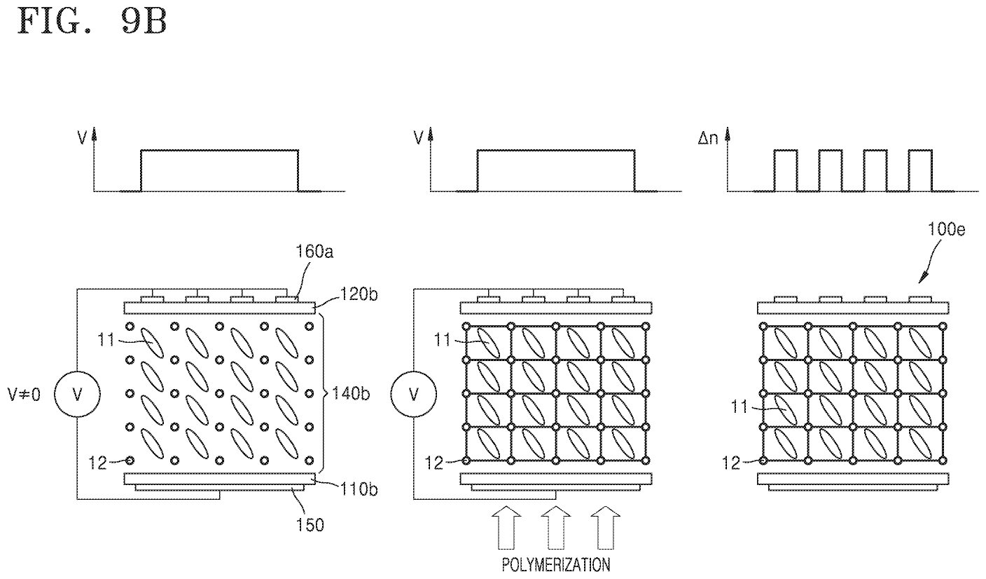

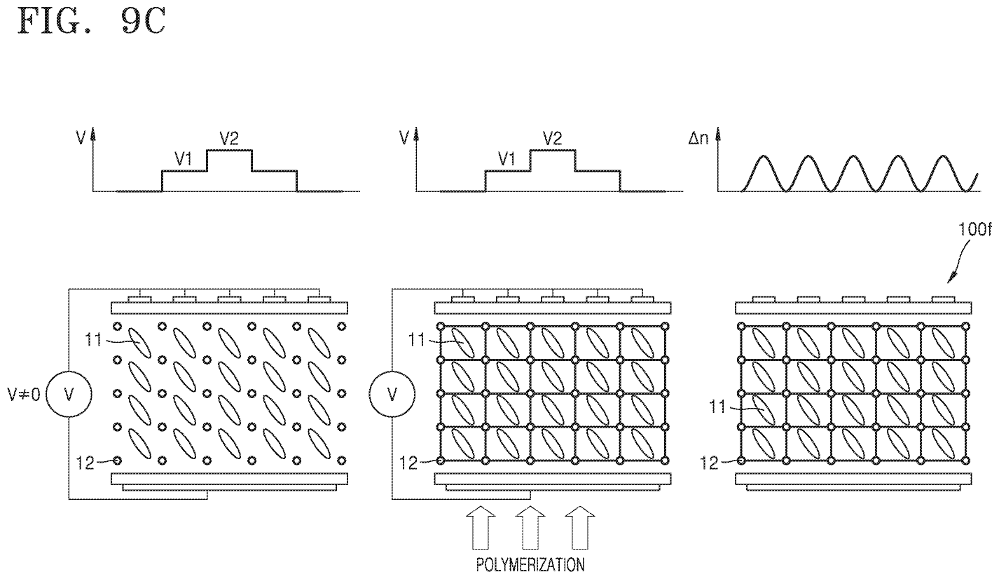

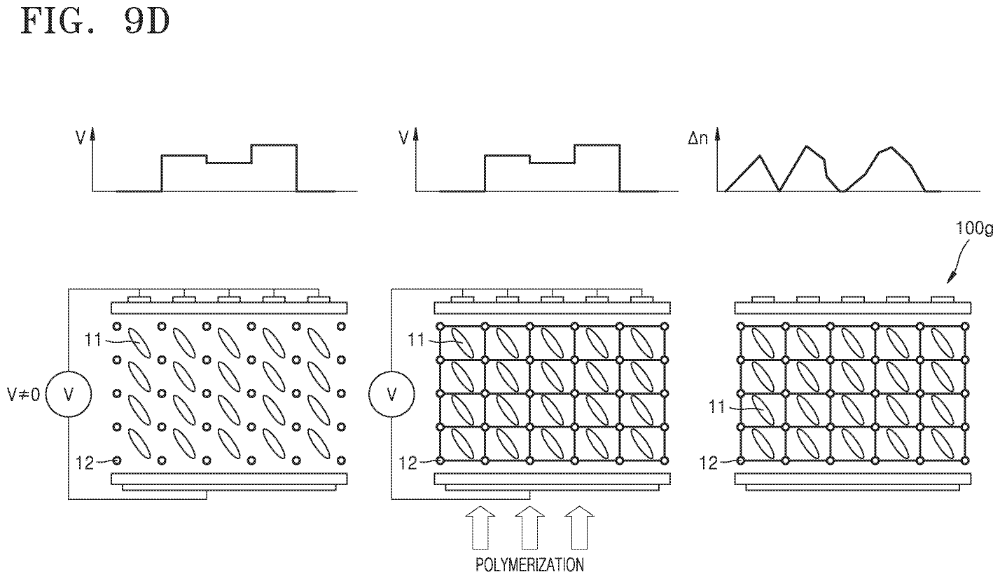

FIG. 9A is a reference diagram for describing a process of manufacturing a diffraction grating structure with a sawtooth refractive index profile recorded therein according to an embodiment of the disclosure.

Referring to FIG. 9A, in order to obtain one tooth of the sawtooth refractive index profile in a diffraction grating structure 100d, voltages V1, V2, and Vn may be applied to the mixture 140b of polymers 12 and liquid crystals 11 by using n discrete electrodes 160a arranged along the length of the second substrate 120b. The discrete electrodes 160a may be supplied with a particular voltage according to a desirable profile of the refractive index. The number of electrodes and the applied voltages V1, V2, Vn may correspond to a desired number of teeth in the profile. Once a voltage is applied, the resulting structure at the voltage may be heated or irradiated with ultraviolet light (depending on the type of polymers 12 used) and the polymers 12 may be polymerized by the light or heat. By the polymerization of the polymers 12, the molecules of the polymers 12 may be fixed and the liquid crystals 11 may be adjusted to the bond thereof. Thus, when the liquid crystals 11 are inserted between the molecules of the polymers 12, the liquid crystals 11 may also be fixed. As a result, the fixed diffraction grating structure 100d may be obtained, and the diffraction grating structure 100d may be used without voltage application.

FIG. 9B is a reference diagram for describing a process of manufacturing a diffraction grating structure with a rectangular profile of refractive indexes according to an embodiment of the disclosure.

Referring to FIG. 9B, in order to obtain one rectangle of the rectangular refractive index profile in a diffraction grating structure 100e, voltage V (any of V1, V2, and Vn) may be applied to the mixture 140b of polymers 12 and liquid crystals 11 by again using the n discrete electrodes 160a arranged along the length of the second substrate 120b.

FIG. 9C is a reference diagram for describing a process of manufacturing a diffraction grating structure with a sinusoidal profile of refractive indexes according to an embodiment of the disclosure.

Referring to FIG. 9C, in order to obtain one waveform of the sinusoidal refractive index profile in a diffraction grating structure 100f, voltages V1 and V2 may be applied to the mixture 140b of polymers 12 and liquid crystals 11 by again using the n discrete electrodes 160a arranged along the length of the second substrate 120b.

FIG. 9D is a reference diagram for describing a process of manufacturing a diffraction grating structure with a random shape profile of refractive indexes according to an embodiment of the disclosure.

Referring to FIG. 9D, in order to obtain one shape of the random shape refractive index profile in a diffraction grating structure 100g, voltage V (any of V1, V2, and Vn) may be applied to the mixture 140b of polymers 12 and liquid crystals 11 by again using the n discrete electrodes 160a arranged along the length of the second substrate 120b. As described above, various types of refractive index profiles may be recorded in the diffraction grating structure according to the magnitude of the voltage applied to the unit electrode.

Next, the refractive index profile based on the period of the interference pattern 132 of FIG. 1 will be described in greater detail. The interference pattern 132 may be formed by irradiating coherent lights with different optical characteristics onto the photodirector layer 130.

When two waves are used to irradiate the photodirector layer 130, the interference pattern 132 irradiating the photodirector layer 130 may look like a band, but the refractive index profile after the application of the liquid crystal layer 140 may be a rectangular shape.

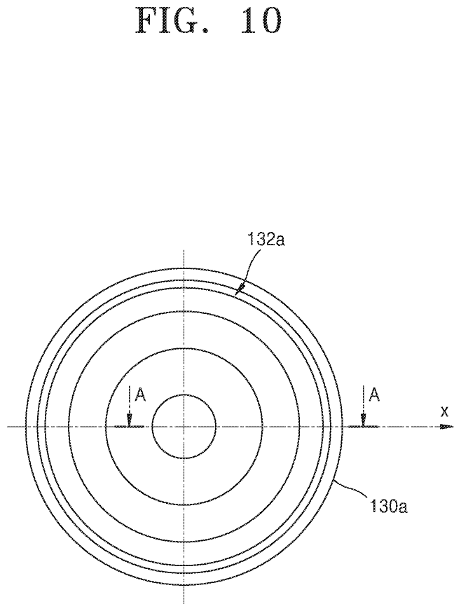

FIG. 10 is a diagram illustrating an interference pattern for a Fresnel lens according to an embodiment of the disclosure.

Referring to FIG. 10, when a plane wave and a square wave are used, a ring-shaped interference pattern 132a may be generated in a photodirector layer 130a.

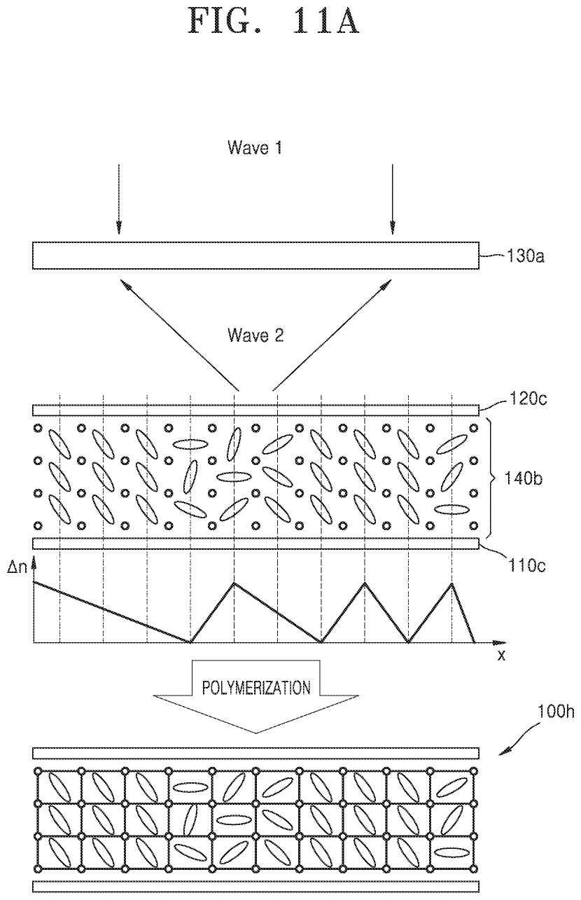

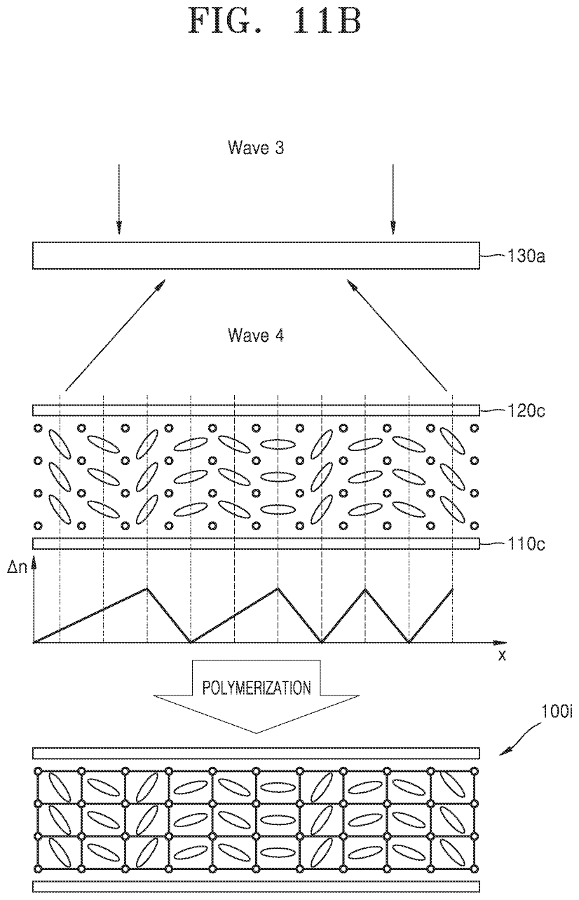

FIG. 11A is a reference diagram for describing a process of manufacturing a diffraction grating structure that may operate as a positive Fresnel lens according to an embodiment of the disclosure, and FIG. 11B is a reference diagram for describing a process of manufacturing a diffraction grating structure that may operate as a negative Fresnel lens according to an embodiment of the disclosure.

Referring to FIGS. 10, 11A and 11B, when a flat-parallel wave (wave 1) is used as the plane wave and a divergent wave (wave 2) is used as the square wave, the ring-shaped interference pattern 132a may be formed in the photodirector layer 130a. At least one of first and second substrates 110c and 120c may include the photodirector layer 130a. When the liquid crystal layer 140b is formed between the first and second substrates 110c and 120c, liquid crystals 11 may be respectively oriented according to the interference pattern 132a as illustrated in FIG. 11A. The liquid crystal layer 140b may include polymers 12 as well as the liquid crystals 11 and thus, the polymers 12 may be polymerized. As a result, a diffraction grating structure 100h may be formed as a positive Fresnel lens.

When the plane wave is a flat-parallel wave (wave 3) and the square wave is a convergent wave (wave 4), a diffraction grating structure 100i may be formed as a negative Fresnel lens as illustrated in FIG. 11B. That is, this structure may be used as a Fresnel lens and may have a thickness of about 100 micrometers. This structure may be applied in application fields such as, for example, manufacturing of prescription lenses. Although not illustrated, first and second electrodes may be further arranged on the first and second substrates 110c and 120c, respectively, and a voltage applied to the first and second electrodes may be used to adjust the orientation direction of the oriented liquid crystals 11. The refractive index of the Fresnel lens may be adjusted.

The diffraction grating structures described above may be formed directly on the waveguide by using the waveguide as the substrate of the diffraction grating structure, or the substrate of the diffraction grating structure may be attached to the waveguide after manufacturing the diffraction grating structure by using a separate substrate. In manufacturing the diffraction grating structure, a structure of the electrode that has been used may be removed after formation or may remain on the diffraction grating structure.

In order to be able to remove the electrode from the diffraction grating structure, it may be made on a sacrificial substrate that is removably applied on the substrate of the diffraction grating structure. For example, in the case of forming a diffraction grating structure, a silicon substrate may be fixed to a substrate onto which a mixture of polymers and liquid, that is, a liquid crystal layer, is applied, and pre-arranged electrodes may be applied onto the silicon substrate when necessary. After forming the diffraction grating structure, the silicon substrate may be easily removed from the obtained structure. As a result, it may be unnecessary to use a power supply.

Various examples of the diffraction grating structure arranged in the waveguide 220 will now be described in greater detail below.

FIG. 12A is a diagram illustrating an example in which one region of a waveguide becomes a substrate of a diffraction grating structure according to an embodiment of the disclosure.

Referring to FIG. 12A, one region of the waveguide 220 may be used as a substrate of a diffraction grating structure 210. Thus, the diffraction grating structure 210 may be manufactured directly on the waveguide 220.

FIG. 12B is a diagram illustrating an example of coupling a diffraction grating structure to one region of a waveguide according to an embodiment of the disclosure.

Referring to FIG. 12B, a diffraction grating structure 210a may be manufactured by using a separate substrate and then coupled onto one region of the waveguide 220.

When a diffraction grating structure has a fixed refractive index profile, an electrode may be removed from the diffraction grating structure.

FIG. 12C is a diagram illustrating an example of a diffraction grating structure without an electrode according to an embodiment of the disclosure.

Referring to FIG. 12C, a diffraction grating structure 210b without an electrode may be arranged on one region of the waveguide 220. Alternatively, when a diffraction grating structure includes polymerized polymers, a liquid crystal layer may be fixed by polymerized polymers.

FIG. 12D is a diagram illustrating an example of a diffraction grating structure without a substrate according to an embodiment of the disclosure.

Referring to FIG. 12D, because a liquid crystal layer alone may perform a function of a diffraction grating structure without a substrate, a diffraction grating structure 210c including only a liquid crystal layer may be arranged on one region of the waveguide 220 as illustrated.

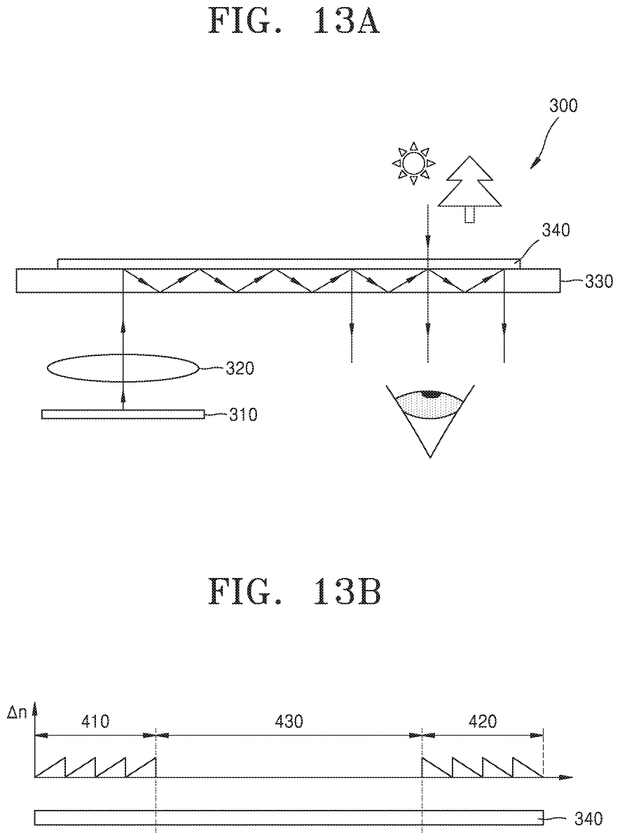

FIG. 13A is a diagram illustrating an example of an augmented reality apparatus including a diffraction grating structure according to an embodiment of the disclosure, and FIG. 13B is a diagram illustrating a refractive index profile of a diffraction grating structure applied in FIG. 13A.

Referring to FIG. 13A, an augmented reality apparatus 300 may include a display 310, an optical system 320 used to match a virtual image and a real image to the user's eyes, a waveguide 330, and a diffraction grating structure 340 arranged on the waveguide 330.

The diffraction grating structure 340 included in FIG. 13A may have a refractive index profile as illustrated in FIG. 13B.

Referring to FIGS. 13A and 13B, a left sawtooth profile 410 of the refractive index profile may allow the input of light, and a right sawtooth profile 420 thereof may allow the output of light. The length of the waveguide 330 is represented in an axis x, and Δn is represented in an axis y.

The augmented reality apparatus 300 illustrated in FIG. 13A may operate as follows.

1. Light may be emitted by the display 310, the light passing through the optical system 320 may be incident on the waveguide 330 with the diffraction grating structure 340 formed thereon, and the light may be diffracted by the diffraction grating structure 340 and then incident on the waveguide 330.

2. Thus, the left sawtooth refractive index profile 410 of the diffraction grating structure 340 may be formed such that the efficiency of an operation diffraction order may be maximized (wherein the diffraction order may be defined as a partial light propagating in a well-defined direction, among the light diffracted on the diffraction grating structure 340).

3. Next, the light may propagate through the waveguide 330 by total internal reflection due to a profile 430 formed at the center of the diffraction grating structure 340.

4. The light may propagate to the diffraction grating structure 340 having an output profile 420. Here, the output profile 420 may mean the right sawtooth profile.

5. The materials of the waveguide 330 and the diffraction grating structure 340 may be transparent. Thus, the user may simultaneously see an image passing through the waveguide 330 and a real view behind the waveguide 330.

That is, the light may enter a region of the waveguide 330 where the left sawtooth profile 410 is located, may propagate through the waveguide 330 (zero modulation line) due to the total internal reflection, and may then be output from a region of the waveguide 330 where the right sawtooth profile 420 is located. The sawtooth profiles 410 and 420 may allow the input and output of light with a diffraction efficiency higher than 90%. It may be known from the diffraction theory and the diffraction grating structure theory. When such efficiency is obtained also in the diffraction grating structure according to an embodiment of the disclosure, an angle for maintaining a wide viewing angle may be selected. Thus, according to the disclosure, it may be possible to generate a wide view together with high diffraction efficiency.

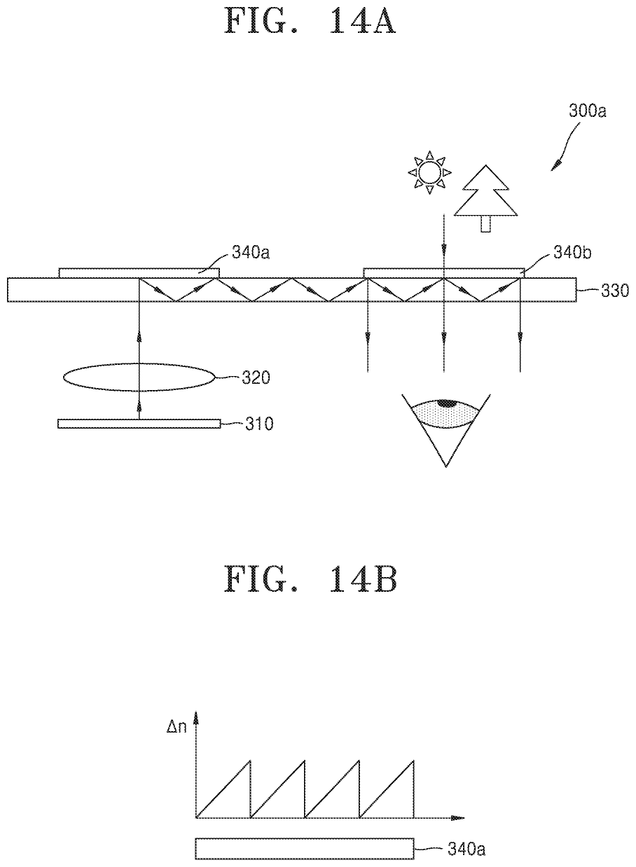

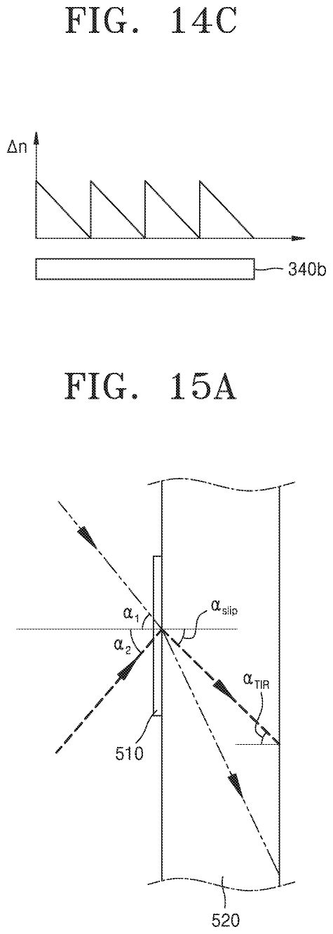

FIG. 14A is a diagram illustrating an augmented reality apparatus including first and second diffraction grating structures according to another embodiment of the disclosure, FIG. 14B is a diagram illustrating a refractive index profile of the a diffraction grating structure of FIG. 14A according to an embodiment of the disclosure, and FIG. 14C is a diagram illustrating a refractive index profile of a second diffraction grating structure of FIG. 14A according to an embodiment of the disclosure.

Referring to FIG. 14A, a first diffraction grating structure 340a of an augmented reality apparatus 300a may be arranged at the input terminal of the waveguide 330 and a second diffraction grating structure 340b may be arranged at the output terminal of the waveguide 330. A desired refractive index profile may be recorded in each of the first and second diffraction grating structures 340a and 340b. For example, a refractive index profile illustrated in FIG. 14B may be recorded in the first diffraction grating structure 340a, and a refractive index profile illustrated in FIG. 14C may be recorded in the second diffraction grating structure 340b. By doing so, the first and second diffraction grating structures 340a and 340b may be formed of the same material or different materials.

A diffraction grating structure according to an embodiment of the disclosure may also be used as a diffraction grating structure of a combiner for an augmented reality apparatus made on a glass window of an automobile, in addition to augmented reality glasses. Due to this use, no additional power supply may be required to operate the diffraction grating structure of the combiner.

Next, the light incidence and viewing angle of the diffraction grating structure will be described in greater detail.

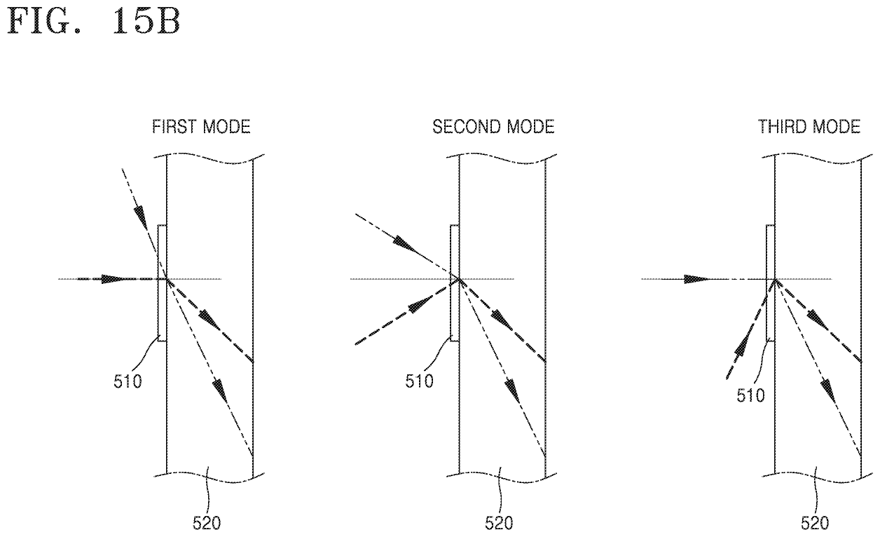

FIG. 15A is a reference diagram illustrating a relationship between a viewing angle and a light propagation path to a diffraction grating structure according to an embodiment of the disclosure.

Referring to FIG. 15A, because FIG. 15A illustrates a field introduced into a waveguide 520, an arrow falls to the waveguide 520. A diffraction grating structure 510 may be an input diffraction grating structure and an output diffraction grating structure having the same frequency. Thus, the viewing angle introduced into the waveguide 520 may be the same as the viewing angle output from the waveguide 520. The viewing angle may mean the maximum angular dimension that may be introduced into the waveguide 520. When a combiner is used in the diffraction grating structure 510, the viewing angle may be limited by two angles, that is, an internal reflection angle arm and a maximum angle αₛₗᵢₚ at which light may propagate in the waveguide 520.

That is, as illustrated in FIG. 15A, viewing angles α₁ and α₂ may be determined by the angles α_{TIR} and αₛₗᵢₚ. That is, the viewing angles α₁ and α₂ may be determined by the characteristics of the diffraction grating structure 510 and the material of the waveguide 520. The total internal reflection angle α_{TIR} and the maximum angle αₛₗᵢₚ at which light may propagate in the waveguide 520 may be related to the angles α₁ and α₂ by Equation 1 below.

n·sin αₛₗᵢₚ−sin α₁=λT or

n·sin α_{TIR}−sin α₁=λT,
where λ is a wavelength,
T is a diffraction frequency, and
n is a refractive index of the waveguide 520.
That is,

α₁=arcsine(n·sin αsₛₗᵢₚ−λT).
It is common knowledge that

α_{TIR}=arcsine(1/n) and

α₂=arcsine(1−λT). Equation 1

In general, α₁ may not be equal to α₂. However, because it may be convenient to arrange an optical axis of an optical system (not illustrated) to be perpendicular to the waveguide 520, an angular arrangement of α₁=α₂ may be most ideal from an ergonomic viewpoint. In this case, the optical system may be located near a temporal fossa in a temple. Alternatively, the optical system may be located at a projector on the head or the side behind the ears. The first case may be impossible and the second case may be inconvenient.

In a virtual reality system, three fields may be classified as an input field of an optical system, a field that may be introduced into a waveguide, and a field (also referred to as a viewing angle) that is output from the waveguide. All three fields may be matched in an optimally-calculated system. Thus, the viewing angle (field of view) may mean the maximum angular dimension that may be introduced into the waveguide.

Also, three modes may be possible according to the axial inclination of the optical axis of the optical system with respect to the normal of the waveguide 520. In this case, the optical system may be axisymmetric.

FIG. 15B is a diagram illustrating three modes of light propagating through a diffraction grating structure and a waveguide according to an embodiment of the disclosure.

Referring to FIG. 15B, a first mode may be a mode when the optical axis of the optical system is inclined at one angle with respect to the diffraction grating structure 510, a second mode may be a mode when the optical axis of the optical system is perpendicular to the diffraction grating structure 510, and a third mode may be a mode when the optical axis of the optical system is inclined at another angle with respect to the diffraction grating structure 510.

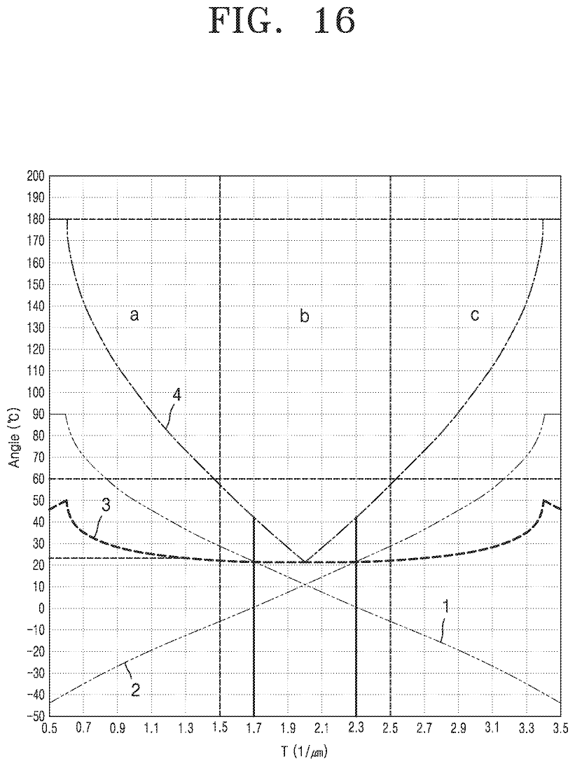

FIG. 16 is a diagram illustrating a viewing angle graph as a frequency function of a diffraction grating structure according to an embodiment of the disclosure.

Referring to FIG. 16, curve 1 may correspond to a change in the angle α₁ as a frequency function of the diffraction grating structure 510, curve 2 may correspond to a change in the angle α₂ as a frequency function of the diffraction grating structure 510, and curve 3 may correspond to a change in the viewing angle with respect to a fixed period grating (the period is the distance between the repetition points of the refractive index profile).

Curve 4 may define the viewing angle of the diffraction grating structure capable of frequency adjustment as the sum of curves 1 and 2.

Because it may not always be convenient to structurally incline the optical axis at one angle, a person may have to work very often in a central region “b”. Because frequency readjustment may depend on the voltage applied to the diffraction grating structure, it may be possible to change the frequency of the diffraction grating structure in using the diffraction grating structure. As a result, it may be possible to obtain a wide viewing angle according to curve 4, for example, a region “a” illustrated on the left side of the graph. However, when the optical system is inclined, the viewing angle may be shifted. Further switching may enable the frequency change of the diffraction grating structure. As a result, a wide viewing angle, for example, a viewing angle like a symmetric region “c” on the right side of the graph, may be obtained according to curve 4. However, the viewing angle will be shifted to the left.

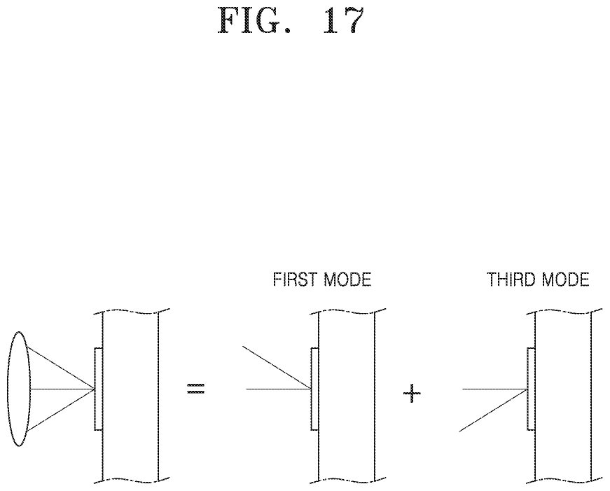

FIG. 17 is a reference diagram for describing an example of dividing a viewing angle into two components according to an embodiment of the disclosure.

Referring to FIG. 17, when the diffraction grating structure 510 has a single period, the diffraction grating structure 510 may not input the entire wide viewing angle to the waveguide 520. Thus, it may be possible to divide a large viewing angle into a plurality of components and sequentially input/output the components.

As illustrated in FIG. 17, one viewing angle may be divided into two portions by using the first mode and the third mode. However, the disclosure is not limited thereto. That is, the viewing angle may be divided into two or more portions. When switching between portions is fast, the eyes will recognize the switching as one large viewing angle without overlooking the switching. When switching between two modes is fast, we may obtain the field sum. Thus, a switching rate that is not overlooked by the eyes may be required. For example, when the field is divided into two portions, the switching rate may be about 120 Hz, and when the field is divided into three portions, the switching rate may be about 180 Hz. At such frequencies, the user will stably recognize the entire view without flickers and other negative effects.

The adjustment of the viewing angle may be implemented by adjusting the frequency (i.e., the period) of the diffraction grating structure. The diffraction grating structure the period or frequency of which may be adjusted may be referred to as a dynamic diffraction grating structure. A dynamic diffraction grating structure 100n may be implemented by the interference pattern 132n, polymerization, and voltage applications described above.

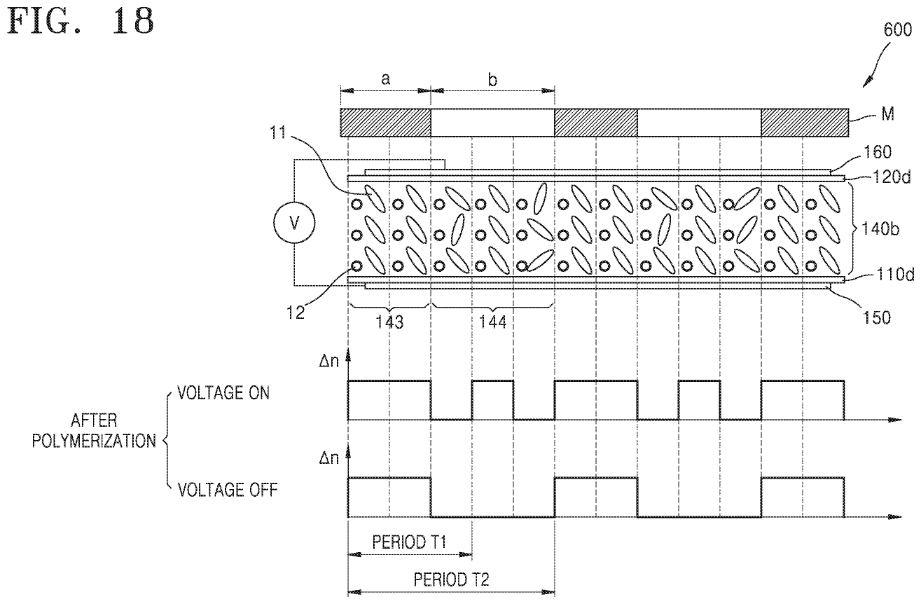

FIG. 18 is a reference diagram for describing a method of implementing a dynamic diffraction grating structure according to an embodiment of the disclosure.

Referring to FIG. 18, the above-described interference photoalignment techniques may be used to realize a dynamic diffraction grating structure 600. A photodirector layer (not illustrated) may be applied onto at least one of first and second substrates 110d and 120d. The photodirector layer may be trained through a photomask (this technique is known from the related art) or by an interference pattern. When the liquid crystal layer 140b is formed between the first and second substrates 110d and 120d, the liquid crystals falling onto an oriented region of the photodirector layer may be oriented and the liquid crystals falling onto a non-oriented region may maintain a chaotic state.

A photomask M may be used for partial polymerization of the liquid crystal layer 140b. The liquid crystal layer 140b may be polymerized in a state where a voltage V is applied to the first and second electrodes 150 and 160. Then, a region 143 of the liquid crystal layer 140b under a first region “a” of the photomask M may be polymerized and a region 144 thereof under a second region “b” of the photomask M may not be polymerized. Even when no voltage is applied to the first and second electrodes 150 and 160, the liquid crystals 11 in the polymerized region 143 may always be rotated. The region 144 under the second region “b”, which is not covered with the photomask M, may not be polymerized and the liquid crystals 11 may move therein. The liquid crystals 11 in the non-polymerized region 144 may be rotated by the applied voltage and change the refractive index. When there is no voltage, the liquid crystals 11 may return to the original state.

A portion corresponding to two columns of the oriented liquid crystals 11 illustrated on the left side of FIG. 18 may be formed by using a mixture of polymers 12 and liquid crystals 11 that may be polymerized. Thus, the refractive index in the region 143 may be constant independent of the applied voltage. The region 144 corresponding to next three columns of the liquid crystals 11 may be obtained by the interference photoalignment method, that is, in this portion, two edge columns of the liquid crystals 11 may be arranged in a chaotic state and may not respond to the applied voltage. Only the liquid crystals 11 in the middle column in the above portion may be oriented according to the applied voltage to change the refractive index thereof. Thus, it is reflected in the graph on the lower side of FIG. 18. That is, the period of the diffraction grating structure 600 when the voltage is not applied thereto may be T2, the period of the diffraction grating structure 600 when the voltage is applied thereto may be T1, and the frequency of the diffraction grating structure 600 may be adjusted according to the voltage. Thus, a diffraction grating structure usable in a compact combiner may be manufactured.

The diffraction grating structure according to an embodiment of the disclosure may not require power supply at all, or may operate with a smaller number of electrodes. The diffraction grating structure according to an embodiment of the disclosure may also be used as a phase modulator with a high spatial resolution. Thus, an augmented reality apparatus having a large viewing angle due to the above diffraction grating structure may be implemented.

Other aspects of the disclosure will become apparent from the description of the embodiments of the disclosure and the drawings. Those of ordinary skill in the art will understand that other embodiments of the disclosure are possible and certain elements of the disclosure may be modified in various ways without departing from the scope and spirit of the disclosure. Thus, the drawings and descriptions should be considered in an illustrative sense only, and not for purposes of limitation. In the appended claims, elements referred to in the singular are not intended to exclude the presence of a plurality of such elements unless explicitly stated otherwise.

While the disclosure has been shown and described with reference to various embodiments thereof, it will be understood by those skilled in the art that various changes in form and detail may be made therein without departing from the spirit and scope of the disclosure as defined by the appended claims and their equivalents.

What is claimed is:

1. A diffraction grating structure comprising:
first and second substrates spaced apart from each other;
a photodirector layer arranged between the first and second substrates and comprising an interference pattern formed therein; and
a liquid crystal layer arranged on the photodirector layer and comprising liquid crystals,
wherein the liquid crystals comprise liquid crystals oriented to correspond to the interference pattern and liquid crystals arranged in a chaotic state.

2. The diffraction grating structure of claim 1, wherein the oriented liquid crystals are arranged on a region of the photodirector layer where an intensity of the interference pattern is nonzero.

3. The diffraction grating structure of claim 1, wherein the liquid crystals arranged in the chaotic state are arranged on a region of the photodirector layer where an intensity of the interference pattern is zero.

4. The diffraction grating structure of claim 1, wherein the photodirector layer comprises a polyimide material.

5. The diffraction grating structure of claim 1, wherein the interference pattern is formed by irradiating a plurality of lights with different optical characteristics.

6. The diffraction grating structure of claim 5, wherein polarization characteristics of at least two of the plurality of lights are different from each other.

7. The diffraction grating structure of claim 1,
wherein the liquid crystal layer further comprises polymers, and
wherein at least some of the polymers are polymerized.

8. The diffraction grating structure of claim 7, wherein the polymerized polymers are aligned in an orthogonal structure.

9. The diffraction grating structure of claim 1, further comprising first and second electrodes arranged on the first and second substrates respectively.

10. The diffraction grating structure of claim 9, wherein the oriented liquid crystals and the liquid crystals arranged in the chaotic state overlap the first and second electrodes in a thickness direction of the liquid crystal layer.

11. The diffraction grating structure of claim 9, wherein the liquid crystals arranged in the chaotic state maintain the chaotic state even with a voltage applied to the first and second electrodes.

12. The diffraction grating structure of claim 9, wherein an orientation direction of the oriented liquid crystals is adjusted according to a voltage applied to the first and second electrodes.

13. The diffraction grating structure of claim 1, wherein a spatial resolution of the diffraction grating structure is determined by a resolution of the interference pattern.

14. The diffraction grating structure of claim 1, wherein the first substrate comprises a waveguide.

15. An augmented reality apparatus comprising:
a waveguide; and
a diffraction grating structure arranged on the waveguide, the diffraction grating structure comprising:
first and second substrates spaced apart from each other,
a photodirector layer arranged between the first and second substrates and comprising an interference pattern formed therein, and
a liquid crystal layer arranged on the photodirector layer and comprising liquid crystals,
wherein the liquid crystals comprise liquid crystals oriented to correspond to the interference pattern and liquid crystals arranged in a chaotic state.

16. A method of manufacturing a diffraction grating structure, the method comprising:
applying a photodirector layer on a substrate;
irradiating a plurality of lights with different optical characteristics onto the photodirector layer to form an interference pattern in the photodirector layer; and
arranging liquid crystals on the photodirector layer with the interference pattern formed therein to arrange some of the liquid crystals in an oriented state and arrange the others of the liquid crystals in a chaotic state.

17. The method of claim 16, wherein the arranging of the liquid crystals comprises:
arranging the liquid crystals in the oriented state on a region of the photodirector layer where an intensity of the interference pattern is nonzero; and
arranging the liquid crystals in the chaotic state on a region where an intensity of the interference pattern is zero.

18. The method of claim 16, wherein polarization characteristics of at least two of the plurality of lights are different from each other.

19. The method of claim 16, wherein the plurality of lights comprise at least one of a plane wave, a square wave, a convergent wave, a divergent wave, or a parallel wave.

20. The method of claim 16, further comprising mixing the liquid crystals with polymers.
